(19) United States
(12) Patent Application Publication
(10) Pub. No.: US 2010/0226641 A1
(43) Pub. Date: Sep. 9, 2010

(54) Camera Holder

(76) Inventor: Andrei LÖWEN, Pforzheim (DE)

Correspondence Address: WALTER A. HACKLER, 2372 S.E. BRISTOL, SUITE B, NEWPORT BEACH, CA, 92660-0755, US

(21) Appl. No.: 12/717,285

(22) Filed: Mar. 4, 2010

(30) Foreign Application Priority Data
Mar. 5, 2009 (DE) 102009011979.5-51

(51) Int. Cl. G03B 17/00

(52) U.S. Cl. 396/419

(57) ABSTRACT

The invention refers to a camera holder comprising a clamp (1), which has two arms (1a, 1b). One of these arms (1a) carries a mount (2) designed as an angular piece, which has a continuous opening for a screw (3) to be inserted and fixed in a tripod connection of a camera. The mount (2) is fixed with a revolute joint in a rotatable manner on the on the clamp (1).

The invention refers to a camera holder with a clamp and a screw that can be inserted in a stand or tripod fitting of a camera. Camera holders for digital compact cameras are known in the form of clamp-on tripods or mini tripods. However, the known clamp-on tripods or mini tripods are quite difficult to handle. Moreover, these tripods almost nullify the most important advantage of digital compact cameras, i.e. less weight coupled with a small volume. For this reason, hobby photographers, who use digital compact cameras, are generally unable to reap the benefits of a tripod or a camera holder, since carrying along the corresponding accessories might prove to be quite cumbersome.

Therefore, this invention aims at presenting ways of simplifying the use of digital compact cameras.

This can be achieved with a camera holder unit having the features mentioned in claim 1. Advantageous modifications of the invention are subject matter of dependent claims.

A camera holder according to this invention has a clamp with a mount, which has a continuous opening for a screw to be inserted into the stand fitting of a camera in such a way that, when the camera holder is fixed to a camera, the screw projects through the mount.

Thus, a camera holder according to the invention makes it easy to carry a digital compact camera, as the screw can be fixed in the camera tripod fitting and the clamp can be attached to the belt or the strap of a shoulder bag. Since the screw projects through the mount, the camera can be aligned parallel to the clamp and be carried in a compact manner close to the belt; thus, one doesn't have to bear the weight of the equipment. When the photographer wants to use the camera, he can quickly remove the camera holder along with the camera from his belt. This is faster than removing the camera from the usual carrying bag. Thus, the camera holder according to the invention simplifies the handling of compact digital cameras in many ways.

While conventional carrying bags and tripods fulfil only a single function each, a camera holder according to the invention combines several functions. Another advantage of a camera holder according to the invention is that it can also be used as a carrying clip, mounting stand, handle or safety clamp. Particularly, a compact camera can be easily carried with an open lens, so that the photographer can quickly shoot whenever he gets the opportunity. Thus, a camera holder according to the invention offers a great deal of user comfort and simultaneously dispenses with bulky camera accessories.

The mount is an angular piece and can, for example, be designed in an L or T shape, so that the camera along with the fixed camera holder remains flat and is compact. The angular piece is preferably right-angled. The two arms of the angular piece can also enclose an angle that deviates by a few degrees without leading to any major disadvantages.

The mount is fixed to the clamp with a revolute joint, so that it rotates. Thus, when the photographer wants to take a snap, he need not unscrew the holder from the camera, but simply turn the clamp away from its carrying position in which it blocks the camera screen. Thus, the clamp can in a way extend the camera in a first rotation angle position and can be used as a stand or holder. In another rotation angle position, turned by 180°, a compact assembly is formed out of the camera holder and the camera, which is particularly convenient for carrying, e.g. on the belt. Here, the revolute joint preferably interlocks in the given rotation angle positions, e.g. in two rotation angle positions that differ by 180°. In addition to this, an interlocking in four rotation angle positions that differ by 90° can be provided for.

According to another advantageous modification of the invention, at least one of the clamp arms carries a securing hook on its free end, because of which a minimum distance is maintained between the two arms when the clamp is closed. A securing hook can ensure that the two arms essentially run parallel to one another when the clamp is closed. Thus, the closed clamp is advantageously flat and can be used nicely as a holder (just like an arm), e.g. while shooting with the camera.

Further details and advantages of the invention are explained with the help of an embodiment with reference to the drawings attached herewith. In the figures:

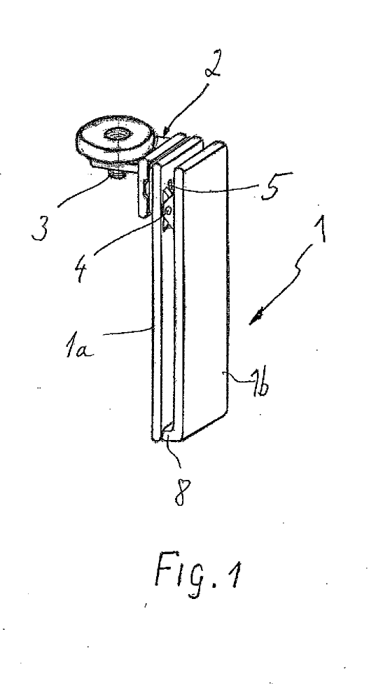

FIG. 1 shows an isometric view of an embodiment of a camera holder according to the invention;

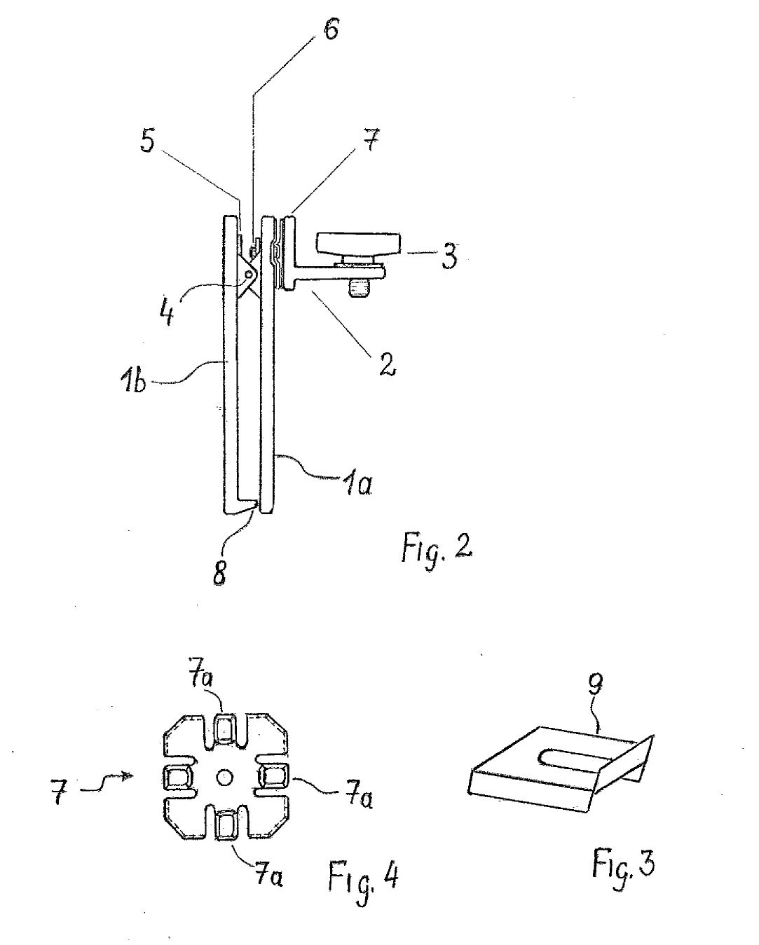

FIG. 2 shows a lateral view of the camera holder shown in FIG. 1;

FIG. 3 shows an accessory of the camera holder; and

FIG. 4 shows the locking mechanism of the camera holder's revolute joint.

The camera holder shown in FIGS. 1 and 2 primarily includes a clamp 1 with arms 1a, 1b and a mount 2, which is fixed to the clamp on a revolute joint. A screw 3 can be inserted through a continuous opening of the mount 2, so that the screw 3 projects through the mount 2 when the camera holder is fixed to a camera. The opening is preferably designed as a long hole, so that it can be easily adapted to the compact cameras of different makes. By inserting the screw 3 in the long hole, the distance of the screw 3 from the clamp 1 can be set according to the thickness of a compact camera and the position of the tripod fitting.

The clamp 1 has two arms 1a, 1b, which can be swivelled against one another for opening the clamp. In the given embodiment, the two arms 1a, 1b are joined with a bolt 4, around which they can be swivelled against the resetting force of a spring 5. In principle, the clamps can also be manufactured as one piece, e.g. by folding a metal strip, in such a way that their ends lie one on top of the other and form two moving clamp arms. One of the arms or both the arms of the clamp can be provided with an anti-skid lining on the inner side, e.g. foamed material.

In the given embodiment, the mount 2 is an L-shaped angular piece. The plate-shaped arms of the angular piece form a right angle. One of the arms has an opening for the screw, while the other arm is fixed on the clamp 1. The arm of the angular piece, in which the screw 3 is fixed, is perpendicular to the clamp arm 1a, on which the angular piece is fixed. The angular piece can also carry a stopper 9, e.g. a sheet metal part with contact edge, for securing a camera fitted with the screw or as a safety against skewing. An example of such a stopper is shown in FIG. 3.

Mount 2, which is designed as an angular piece, is fixed onto the clamp 1 with a revolute joint, so that it is rotatable. The revolute joint is a uniaxial pivoting joint, whose axis of rotation can, e.g. be created with a screw or rivet 6, and is perpendicular to the screw 3 and to the clamp arm 1a that supports it. The revolute joint includes a snap-in locking device that can be locked in predefined rotation angle positions, e.g. the rotation angle position shown in FIG. 1 and an opposite rotation angle position skewed by 180°.

The snap-in locking device can be realised, e.g. with a spring washer 7 shown in FIG. 4. The spring washer 7 has several (in the shown embodiment four) spring elements 7a, which, in the specified rotation angle positions, engage in a locking washer (not shown) in the recesses meant for this purpose and thus initiate a locking process in four rotation angle positions that differ by 90°. A locking washer can dispensed with by providing recesses on the clamp arm 1a or the mount 2.

In principale, a locking process can be initiated even without a spring washer 7 in the given rotation angle position, e.g. by providing the mount 2 or its supporting clamp arm 1a with humps, which engage in the corresponding recesses in the clamp bracket 1a or mount 2. Such a design can be particularly of advantage in a plastic clamp arm or mount.

One of the two arms of the clamp 1 has a securing hook 8 on its free end. Because of the securing hook 8, the corresponding arm 1b of the clamp 1 becomes a hook, so that the clamp 1 can e.g. be hooked on to a belt in a form-fit manner. In addition to this, the securing hook 8 maintains a minimum distance between the two arms when the clamp 1 is closed. Thus, the two arms 1a, 1b, as shown in the embodiment, run more or less parallel to one another, i.e. they enclose an angle, which does not deviate by more than 5° from 180°. Since the arms of the clamp 1 run parallel to one another, we get the advantage of a slender and compact design.

Tripod fittings of cameras generally have a ¼-inch thread. Thus, the screw 3 of the shown camera holder is preferably a ¼-inch screw. Knurled screws are particularly suitable. The screw 3 can be fixed on the mount 2 in a captive manner. However, the screw can also be designed as a removable screw. An advantage of the removable screw is that the screw 3 can be inserted through the mount 2 from both the directions, e.g. for better adaptability to compact cameras having different dimensions. Here, the opening of the mount should be provided with a thread, so that the screw does not become loose and come out accidentally. This can also be prevented by using special flat washers, e.g. made from elastomer. An elastomer, e.g. hard rubber, can be pasted on the mount; it can have an opening having a width less than the outer diameter of the screw 3 thread. Because of the elastomeric deformability of the mount lining, it is possible to insert the screw through the opening and fix it; however, this can hardly take place unintentionally.

A support ring can be additionally fixed on the knurled screw 3. For example, a screw can be fixed by turning in the screw 3 head for fixing a support ring and/or cord.

### REFERENCE NUMBERS

1 Clamp
1a, 1b Clamp arms
2 Mount
3 Screw
4 Bolt/Stud
5 Spring
6 Rivet
7 Spring washer
7a Spring elements
8 Securing hook
9 Stopper

1. Camera holder comprising
a clamp, which has two arms, one of the arms carrying a mount designed as an angular piece, which has a continuous opening for a screw to be inserted and fixed in a tripod connection of a camera; wherein
the mount is fixed in a rotatable manner on the on the clamp.

2. Camera holder according to claim 1, wherein the opening is a long hole.

3. Camera holder according to claims, wherein the angular piece is right-angled.

4. Camera holder according to claim 1, wherein the angular piece has two plate-shaped arms, one of the arms having the opening and the other arm being fixed to the clamp.

5. Camera holder according to claim 1, wherein the mount is fixed on the clamp by a revolute joint that locks in at least one specified rotation angle position.

6. Camera holder according to claim 5, wherein the revolute joint locks in at least two rotation angle positions, which differ by 180°.

7. Camera holder according to claim 5, wherein the revolute joint has spring elements, which engage in the corresponding recesses for locking.

8. Camera holder according to claim 1, wherein at least one of the arms of the clamp has a securing hook on its free end, because of which a minimum distance is maintained between the two arms when the clamp is closed.

9. Camera holder according to claim 1, wherein the two arms are substantially parallel when the clamp is closed.

10. Camera holder according to claim 1, wherein the clamp comprises a spring, whose resilience effects a closing of the clamp.

11. Camera holder according to claim 1, wherein the screw is a knurled screw.

12. Camera holder according to claim 1, wherein the opening of the mount defines the orientation of the screw in such a way that the screw projecting through the mount runs parallel to the arm of the clamp, on which the mount is fixed.

13. Camera holder according to claim 1, wherein, at least one of the arms of the clamp has an anti-skid lining on its inner side.
